(19) United States
(12) Patent Application Publication
(10) Pub. No.: US 2023/0098006 A1
(43) Pub. Date: Mar. 30, 2023

(54) Method and System for Collecting and Managing Vehicle-Generated Data

(71) Applicants: Hyundai Motor Company, Seoul (KR); Kia Corporation, Seoul (KR)

(72) Inventors: Seung Wook Park, Yongin-si (KR); Wha Pyeong Lim, Hwaseong-si (KR)

(21) Appl. No.: 17/908,648

(22) PCT Filed: Feb. 26, 2021
(86) PCT No.: PCT/KR2021/002435

§ 371 Date: Sep. 1, 2022

(30) Foreign Application Priority Data
Mar. 4, 2020 (KR) 10-2020-0027455
Feb. 25, 2021 (KR) 10-2021-0025820

(51) Int. Cl. G07C 5/02; G06F 21/62

(52) U.S. Cl. CPC G07C 5/02; G06F 21/6218

(57) ABSTRACT

An embodiment method, performed by at least one server on a network for collecting and managing vehicle-generated data from a vehicle, includes receiving an event report message and an interaction report message from the vehicle, the event report message including vehicle identification information and event data stored by an event data recorder of the vehicle, and the interaction report message including the vehicle identification information and interaction data indicative of an interaction between an autonomous driving system of the vehicle and a driver, generating link data from the vehicle identification information and a salt, storing the vehicle identification information and the salt in a first database, storing the event data and the link data in a second database, and storing the interaction data and the link data in a third database.

### CROSS-REFERENCE TO RELATED APPLICATIONS

This application is a national stage application of International Application No. PCT/KR2021/002435, filed on Feb. 26, 2021, which claims priority to Korean Patent Application No. 10-2020-0027455, filed on Mar. 4, 2020, and Korean Patent Application No. 10-2021-0025820, filed on Feb. 25, 2021, which applications are hereby incorporated herein by reference.

### TECHNICAL FIELD

The present disclosure relates to collecting and managing data generated by a plurality of vehicles.

### BACKGROUND

The statements in this section merely provide background information related to the present disclosure and do not necessarily constitute prior art.

An event data recorder (EDR) is configured to detect an accident or such event and store information about a driving state of a vehicle or an operation by a driver within a predetermined time before and after the event. At least several parameters, including speed, seat belt status, and airbag deployment status, are stored for reconstruction during forensic investigations.

Forensic investigation is generally performed using a vehicle diagnostic link connector, e.g., an on-board computer (OBD)-II port or by physically extracting an EDR data memory and reading data therefrom. Data in the EDR is susceptible to damage or alteration due to faulty reading technology and may be maliciously manipulated or deleted after storing, which exhibits the difficulty of ensuring complete data integrity for the stored data.

With more vehicles being given the benefit of ADAS (Advanced Driver Assistance Systems) or autonomous driving functions, traffic accidents are becoming more attributed to vehicles than to the drivers. For proper clarification of causes of an accident, there is a growing demand to collect data in addition to the data recorded by the existing Event Data Recorder (EDR), such as additional information regarding the operational status of the ADAS or autonomous driving functions, the detailed determination by the vehicle system on the sensor input, etc.

With the development of information and communication technology, such vehicle data may be collected in various forms by a data server on a network and provided to various service providers. Some information collected by the data server may be sensitive in terms of personal privacy. Since the operator had real control and sales rights for personal information in these data servers, the individual had to take a lot of risks.

Moreover, as legislation on privacy protection, such as the European General Data Protection Regulation (GDPR), has been implemented, it is required to introduce a system that can efficiently collect and utilize vehicle-generated data within the legal boundaries.

### SUMMARY

Embodiments of the present disclosure present a general concept of a data storage system of a vehicle having a communication function and a cloud storage system that collects and manages vehicle-generated data. The concept focuses on overcoming the limitations of in-vehicle data storage and maximizing user access to vehicle-generated data. Embodiments of the present disclosure, in particular, present data storage and management methods that may protect personal privacy in a cloud system.

In accordance with one embodiment of the present disclosure, a method, performed by at least one server on a network for collecting and managing vehicle-generated data from vehicles, comprises receiving an event report message and an interaction report message from a vehicle. The event report message comprises vehicle identification information and event data stored by an event data recorder of the vehicle, and the interaction report message comprises the vehicle identification information and interaction data indicative of an interaction between an autonomous driving system of the vehicle and a driver. The method further comprises generating link data from the vehicle identification information and a salt, storing the vehicle identification information and the salt in a first database, storing the event data and the link data in a second database, and storing the interaction data and the link data in a third database.

Embodiments of the method may include one or more of the following features.

In some embodiments, the method further comprises deleting the vehicle identification information or the salt from the first database when it is required to remove an association between the vehicle identification information and the event data and an association between the vehicle identification information and the interaction data.

In some embodiments, the method further comprises maintaining the event data and the interaction data in the second database and the third database and deleting the vehicle identification information of the vehicle or the salt from the first database, in response to expiration of a validity period set by a vehicle owner of the vehicle.

In some embodiments, the method further comprises receiving, from a vehicle owner of the vehicle, a request message requesting deletion of at least one of the vehicle identification information, the event data, and the interaction data, and the method further comprises deleting at least one of the vehicle identification information, the link data, the event data, and the interaction data from a related database, in response to receiving the request message.

In some embodiments, the method further comprises mitigating a security level of a right to use related event data and interaction data stored in the second database and the third database, in the case of deleting the vehicle identification information or the salt from the first database.

In some embodiments, the event data or interaction data for which the security level is not mitigated may be retrieved from the second database or the third database based on the link data reconstructed from the salt and related vehicle identification information stored in the first database, and the event data or interaction data for which the security level is mitigated may be allowed to be retrieved directly from the second database or the third database without the reconstructed link data.

In some embodiments, the link data is generated by applying a one-way hash function to the vehicle identification information and the salt.

In some embodiments, the vehicle identification information is a vehicle identification number (VIN), and the link data is a de-identified version of the VIN generated from the salt and the VIN. The de-identified version of the VIN is generated by (1) generating a hash value by applying a one-way hash function to a concatenation of the salt and some digits of the VIN of the vehicle and (2) replacing the some digits of the VIN with the hash value.

According to one embodiment of the present disclosure, a cloud storage system for collecting and managing vehicle-generated data from vehicles is provided. The cloud storage system is implemented by at least one server on a network and comprises means for receiving an event report message and an interaction report message from a vehicle. The event report message comprises vehicle identification information and event data stored by an event data recorder of the vehicle, and the interaction report message comprises the vehicle identification information and interaction data indicative of an interaction between an autonomous driving system of the vehicle and a driver. The system further comprises means for generating link data from the vehicle identification information and a salt, means for storing the vehicle identification information and the salt in a first database, and means for storing the event data and the link data in a second database and storing the interaction data and the link data in a third database.

Embodiments have advantageous effects. A centralized system that collects and manages EDR/DSSAD (data storage system for automated driving vehicles) data from vehicles may free vehicle data recorders from storage space constraints. For example, an event data recorder may be designed to collect EDR data related to a previously ignored minor incident using more trigger conditions than conventionally, and may be designed to collect a wider variety of data elements (for example, radar/lidar data obtained before and after an event, V2X messages, etc.) that may further facilitate ex-post analysis of an event.

Individuals or institutions may easily obtain EDR/DSSAD data of interest in a timely manner from a centralized system. In addition, EDR/DSSAD data stored in storage on a trusted network may be useful for forensic investigations that require ensuring the integrity of the data. EDR data and DSSAD data are complementary. In particular, DSSAD data is useful for identifying a subject who was controlling the vehicle at the time of collision.

In the proposed centralized system, the EDR/DSSAD data recorded in each vehicle is stored and managed in databases on the network along with link data, separated from vehicle identification information (VII), which allows a third party to identify or track the related vehicle. Link data may be cryptographically (re)generated based on the vehicle identification information and salt stored in a VII database. Accordingly, by deleting the vehicle identification information or salt from the VII database, the association between the vehicle identification information and related EDR/DSSAD data may be removed.

### BRIEF DESCRIPTION OF THE DRAWINGS

FIG. 1 is a schematic diagram illustrating a centralized system for collecting and managing event data from vehicles according to an embodiment of the present disclosure.

FIG. 2 is a conceptual diagram illustrating an exemplary method for separately storing vehicle identification information (VII), EDR data, and DSSAD data in databases according to an embodiment of the present disclosure.

FIG. 3 is a diagram for explaining details of a vehicle identification number (VIN).

FIG. 4 illustrates an example of a de-identified version of the VIN and an EDR identified thereby, according to an embodiment of the present disclosure.

FIG. 5 is a conceptual diagram illustrating an exemplary method for inquiring and providing EDR/DSSAD data for a specific vehicle by a cloud storage system according to an embodiment of the present disclosure.

FIG. 6 is a conceptual diagram illustrating an exemplary method for a cloud storage system to delete VII/EDR/DSSAD data per request of a vehicle owner, according to an embodiment of the present disclosure.

FIG. 7 is a flow diagram illustrating an EDR data collection process of the system shown in FIG. 1, in accordance with an embodiment of the present disclosure.

### DETAILED DESCRIPTION OF ILLUSTRATIVE EMBODIMENTS

Hereinafter, some embodiments of the present disclosure will be described in detail with reference to the accompanying drawings. In the following description, like reference numerals designate like elements, although the elements are shown in different drawings. Further, in the following description of some embodiments, a detailed description of known functions and configurations incorporated therein will be omitted for the purpose of clarity and for brevity.

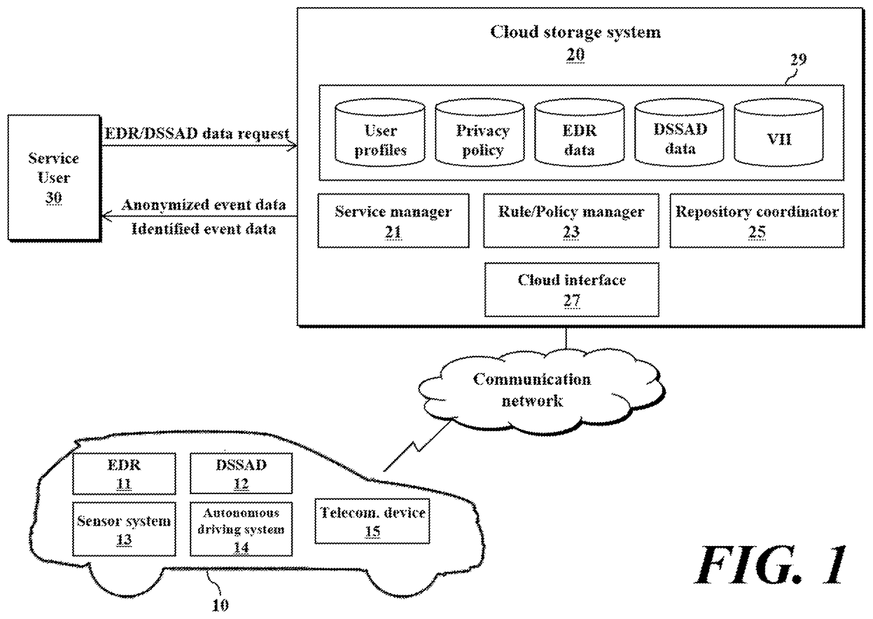

FIG. 1 is a schematic diagram illustrating a centralized system for collecting and managing vehicle-generated data from vehicles according to an embodiment of the present disclosure.

The system includes an in-vehicle data recording system 10 provided in a vehicle, and a cloud storage system 20 implemented as server(s) on a network. The server(s) implementing the cloud storage system 20 may be server(s) operated by a vehicle manufacturer or server(s) operated by an operator who is independent of the vehicle manufacturers, or may include a combination thereof.

A vehicle is configured to operate fully or partially in an autonomous driving mode and may therefore be referred to as an “autonomous driving vehicle.” For example, an autonomous driving system 14 may receive information from a sensor system 13 and execute, in an automated manner, one or more control processes based on the received information (for example, setting steering to avoid detected obstacles).

A vehicle may be fully autonomous or partially autonomous. In a partially autonomous vehicle, some functions may be temporarily or continuously controlled manually by a driver. Further, the fully autonomous vehicle may be configured to be switchable between a fully manual operating mode and a partially autonomous operating and/or fully autonomous operating mode.

The in-vehicle data recording system 10 may be configured to generate, record, or store various types of data related to vehicle operation or driver behavior. The in-vehicle data recording system 10 includes two types of data recorders: an Event Data Recorder (EDR) 11 and a Data Storage System for Automated Driving Vehicles (DSSAD) 12. They record vehicle-generated data for different purposes.

The purpose of the EDR 11 is to store vehicle information for specific events such as airbag deployment. Data from the EDR 11 is used for collision analysis and reconstruction. The purpose of the DSSAD 12 is to record all predefined interactions between a driver and an autonomous driving system. Data from the DSSAD 12, typically stored in timestamp format, is used to identify a subject who was controlling a vehicle at a particular point in time. The data of the EDR 11 and the data of the DSSAD 12 are used complementary to each other in forensic investigations, and in particular, the data of the DSSAD 12 is useful for identifying a subject who was controlling the vehicle at the time of collision.

The EDR 11 may be configured to receive data from various sensors and/or electronic control units (ECUs) mounted on the vehicle. The EDR 11 has a volatile memory of the EDR 11 that has data for a certain period temporarily stored while being continuously updated. The EDR 11 may be responsive to a detection of the occurrence of one or more predefined events for recording the data that is stored in the volatile memory within a predetermined time before and after the detection. Such an event may in particular be a traffic collision. A traffic collision may be detected, for example, when there is a triggering deployment of an irreversible safety device such as an airbag or seat belt preloading device. A traffic collision may also be detected at the occurrence of acceleration/deceleration exceeding a predefined threshold (e.g., a speed change of 8 km/h or higher within about 150 ms). The predefined event(s) may further include a malfunction of the main function of the vehicle.

The EDR 11 may be configured to receive trigger signal(s) informing of the occurrence of an event from the electronic control unit(s), such as, for example, an airbag control unit (ACU). The EDR 11 may be accessible to values measured by at least one or more sensors of the sensor system 13. At least one sensor of the sensor system 13 maybe configured to detect vehicle speed/acceleration/deceleration/travel distance/geographical position, and the like. The EDR 11 maybe included as a functional module in the airbag control unit (ACU).

The data recorded by the EDR 11 may be data suitable for analyzing traffic collisions, such as, for example, data of vehicle dynamics, driver's behavior, and an operating state of a vehicle safety system. The EDR 11 may be configured to transmit recorded data (hereinafter referred to as “EDR data” or “event data”) to a telecommunication device 15 so as to be transmitted to the cloud storage system 20.

The autonomous driving system 14 may be configured to generate interaction signals indicative of interactions between a driver and the autonomous driving system 14. These interaction signals may include a signal indicating whether one or more autonomous driving functions are currently active. For example, the autonomous driving system 14 may generate a signal indicating whether an adaptive cruise control (ACC) function is currently active. As another example, the autonomous driving system 14 may generate a signal indicating whether driving of a vehicle is currently being controlled fully automatically rather than manually. In addition, these interaction signals may further include signals indicating a transition demand indicating that control of the driving task to a driver needs to be taken over, and signals indicating that control of the driving task to the driver has been taken over. The autonomous driving system 14 may provide interaction signals to the DSSAD 12 via a data bus (for example, CAN bus, Ethernet bus, etc.).

The DSSAD 12 may store interaction data representing interaction between a driver and the autonomous driving system in an internal non-volatile memory based on the interaction signals received from the autonomous driving system 14. The DSSAD 12 is installed on a vehicle equipped with a highly-automated driving system (for example, SAE level 3, 4, 5 classification), and is a data storage system that aims to clarify “subjects requested to drive” and “subjects who actually drove.” During the transition procedure (that is, after the transition demand is issued and until a driver actually takes over control), the “subject requested to drive” and the “subject who actually drove” may be different from each other.

Interaction data may include time-stamped data elements representing specific interaction events, such as, for example, changing the state (switched off, activated, transition demand, override) of the autonomous driving system, starting and ending Minimal Risk Maneuver (MRM) by the autonomous driving system, and taking over control of a driving task to a driver. The DSSAD 12 may provide the stored interaction data (hereinafter, may also be referred to as “DSSAD data”) to the telecommunication device 15 so as to be transmitted to the cloud storage system 20.

DSSAD data may have three fields including a timestamp, a type flag, and an occurrence cause field. The timestamp field indicates the time at which a specific interaction between a driver and a system occurred. DSSAD data requires a high-precision timestamp for that purpose. The type flag field indicates the type of interaction between the driver and the system, such as a transition demand or a minimum risk maneuver. The occurrence cause field indicates the cause of the interaction. The occurrence cause field may be an optional field.

The telecommunication device 15 may be a wired or wireless telecommunication device that connects the vehicle's internal network to an external communication network. The telecommunication device 15 maybe, for example, a telematics unit (TMU), or a wired/wireless dongle plugged into an OBD-II port. The telecommunication device 15 may include a wireless transceiver capable of cellular communication such as GSM/WCDMA/LTE/5G or short-range wireless communication such as WLAN, c-V2X, WAVE, DSRC, Bluetooth, for example.

The telecommunication device 15 may be configured to generate an event report message when EDR data is received from the EDR 11. The telecommunication device 15 may be configured to transmit the event report message to the cloud storage system 20 via the communication network. The event report message may include vehicle identification information (VII) and EDR data received from the EDR 11. In a typical embodiment, the VII may be a vehicle identification number (VIN), which is a 17-digit unique identifier composed of numbers and letters assigned to individual vehicles by vehicle manufacturers. Alternatively, the VII may be a vehicle registration number (or license plate information), a unique identifier used by the telecommunication device 15 for communication, a (long-term or short-term) certificate assigned to a vehicle for V2X communication, and the like. The event report message may further include additional information such as a geographic location, date, and time of occurrence of an event.

The telecommunication device 15 may generate an interaction report message when DSSAD data is received from the DSSAD 12. The telecommunication device 15 may transmit the interaction report message to the cloud storage system 20 via the communication network. The interaction report message may include the vehicle identification information (VII) and the DSSAD data received from the DSSAD 12.

The cloud storage system 20 is a data management system, implemented with servers on a network, that collects and manages EDR data and DSSAD data from a plurality of vehicles.

The cloud storage system 20 may receive an event report message and an interaction report message from a plurality of vehicles. For report messages received from the vehicle, the cloud storage system 20 separates the VII from the EDR/DSSAD data that enables a third party to identify or track the related vehicle or the related individual, so that the VII and the EDR/DSSAD data may be stored in different databases, respectively.

The cloud storage system 20, in response to a request of a user 30 who wants to use the EDR/DSSAD data, may provide anonymized EDR/DSSAD data in which a specific vehicle or individual is not identified, or provide EDR/DSSAD data in which a specific vehicle or individual is identified. The user 30 may be a vehicle owner, a driver, an insurance company, a government agency, a researcher, or a vehicle manufacturer who wants to utilize EDR/DSSAD data. For EDR/DSSAD data in which a specific vehicle or individual has been identified, unless otherwise authorized by a court order, search warrant, and/or other applicable laws and regulations, the cloud storage system 20 needs to be provided only to investigators or other users authorized by the relevant vehicle owner.

The cloud storage system 20 maybe implemented to include a service manager 21, a rule/policy manager 23, a repository coordinator 25, a cloud interface 27, and a data repository 29. The data repository 29 may be implemented by at least one data server.

The service manager 21 is a functional entity, which collects and manages EDR/DSSAD data from vehicles and provides a user with anonymized EDR/DSSAD data in which a specific vehicle or individual is not identified or EDR/DSSAD data in which a specific vehicle or individual is identified. The rule/policy manager 23 is a functional entity for managing user profiles and privacy policy stored in the data repository 29. The repository coordinator 25 is a functional entity for separately storing the EDR data, the DSSAD data and the VII data in the databases of the data repository 29, and retrieving the EDR data, the DSSAD data and the VII data from the databases of the data repository 29. The cloud interface 27 is a functional entity that serves as a gateway of the cloud storage system 20.

The data repository 29 has databases that record user profiles, privacy policy, VII data, EDR data, and DSSAD data. The user profile includes subscription information of individuals, companies, or organizations that have subscribed to the cloud storage system 20. The privacy policy includes a set of privacy rules that apply to the collection and management procedures of each vehicle's EDR/DSSAD data.

The rule/policy manager 23 may be configured to receive, from a vehicle owner, settings for privacy options for personal data (VII/EDR/DSSAD data) collected from the owner's vehicle, and generate a set of privacy rules (that is privacy policies) to be applied to the collection, management, and use of personal data according to the received settings for privacy options.

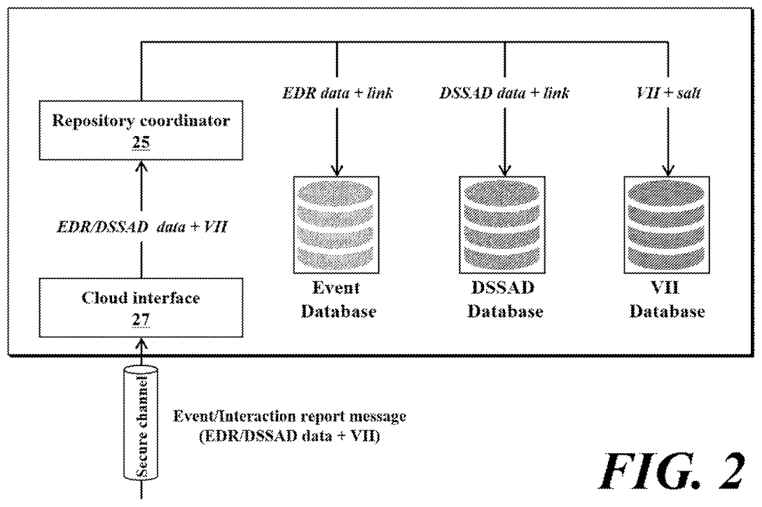

Referring to FIG. 2, an exemplary method in which the cloud storage system 20 separately stores the VII, the EDR data, and the DSSAD data, which are included in report messages received from a vehicle in databases, is described.

The cloud interface 27 may receive an event report message or an interaction report message from a vehicle through a security channel. Each report message may include the EDR data and the VII or may include the DSSAD data and the VII.

The repository coordinator 25 may generate link data for maintaining an association between the EDR/DSSAD data and the VII, which would be stored in different databases. The link data may be generated based at least in part on the VII and a randomly generated value (hereinafter referred to as “salt”). However, the link data itself does not include any meaningful information that identifies a vehicle or individual.

The repository coordinator 25 may divide the information included in each report message into two data sets. A first data set includes EDR/DSSAD data but does not include the VII, and a second data set includes the VII but does not include EDR/DSSAD data. In other words, a vehicle identification number (VIN) or any other unique data that enables identification or tracking of a vehicle or individual involved is separated from the EDR/DSSAD data.

The repository coordinator 25 may store the first data set to which link data is added (that is, link data and EDR/DSSAD data) in EDR/DSSAD databases. The repository coordinator 25 may store the second data set to which the salt is added (that is, salt and VII) in the VII database.

The link data may be a pseudonym identifier generated based at least in part on the VII. In some embodiments, the pseudonym identifier may be generated by applying a one-way hash function to the VII. The one-way hash function makes it impossible to extract the VII or other useful information from the pseudonym identifier. Preferably, the pseudonym identifier may be generated by applying a one-way hash function to the concatenation of the VII and a salt. The salt used to generate the pseudonym identifier may be stored in the VII database along with the related VII. Herein, a one-way hash function has been described as an example, but other types of cryptographical algorithms for generating pseudonymous identifiers may be used.

In some embodiments, the link data may be a de-identified version of the vehicle identification number (VIN). As described above, the VIN is a 17-digit unique identifier composed of numbers and letters assigned to individual vehicles by vehicle manufacturers. The de-identified version of the VIN may be generated by cryptographically de-identifying at least some digits of an original VIN including a production serial number.

As will be explained below, each digit of a VIN has a specific purpose.

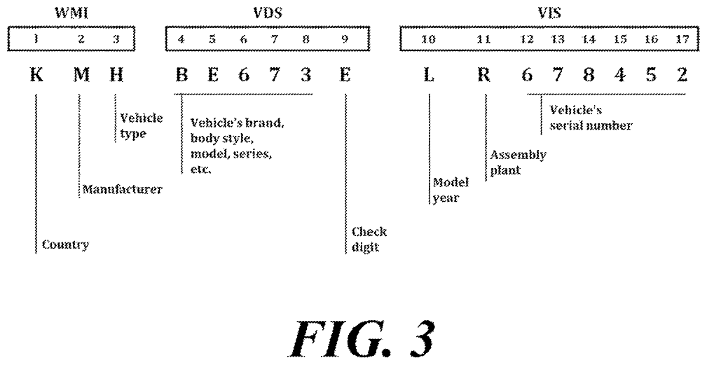

FIG. 3 is a diagram for explaining details of a vehicle identification number (VIN).

The first three digits of the VIN, which are known as a world manufacturer identifier (WMI) or a WMI code, provides information on a manufacturer of a vehicle and a geographical location where the vehicle was manufactured.

The first digit of the VIN represents a country in which the vehicle is manufactured. This digit may be a letter or a numeral. For example, “1,” “4,” or “5” in the first digit represents the country of origin as America. “2” represents Canada, “3” represents Mexico, “6” represents Australia, “A” represents South Africa, “J” represents Japan, “L” represents China, and “K” represents Korea.

The second digit of the VIN represents a vehicle manufacturer but should be paired with the first digit (represents a manufacturing country) to accurately decode the manufacturer. For example, a VIN beginning with “1C” represents a vehicle manufactured by Chrysler in America, and a VIN beginning with “AC” represents a vehicle manufactured by Hyundai in South Africa.

The third digit represents a vehicle type or a manufacturing division. In a VIN beginning with “WV1,” “W” represents Germany as a manufacturing country, and “V” represents Volkswagen as a manufacturer. “1” represents a commercial vehicle of Volkswagen. The VINs of Volkswagen buses or vans begin with “WV2,” and the VINs of Volkswagen trucks begin with “WV3.”

The fourth to eighth digits of the VIN constitute a vehicle descriptor section (VDS), and represent vehicle features such as vehicle body style, an engine type, a model, and a series. Each manufacturer uses these five-digit fields in its own way.

The ninth digit is a check numeral for identifying an invalid VIN. This numeral is determined from numeric values of the first eight digits and the last eight digits according to a mathematical formula.

The tenth to seventeenth digits of the VIN are known as a vehicle identifier section (VIS). These provide a much more detailed description of the specific vehicle.

The tenth digit represents a model year of the vehicle. Letters from B to Y correspond to models between the years 1981 and 2000. VINs do not use I, O, Q, U, or Z. Between the years 2001 and 2009, numerals from 1 to 9 were used instead of letters. The English alphabet is used for the years 2010 to 2030 beginning with A. Model years of 2000 or later are as follows: Y=2000, 1=2001, 2=2002, 3=2003, . . . , 9=2009, A=2010, B=2011, C=2012, . . . , K=2019, and L=2020.

The eleventh digit represents an assembly plant in which the vehicle was assembled. Each VM has its own set of plant codes. The last six digits (from the twelfth digit to the seventeenth digit) represent a production serial number of the vehicle.

The repository coordinator 25 parses the VIN to extract a serial number, and applies a one-way hash function to the concatenation of the salt and the serial number to generate a hash value. The repository coordinator 25 may generate a de-identified version of the VIN by replacing the serial number of the VIN with the generated hash value. In other words, the de-identified version of the VIN may have a masked production serial number.

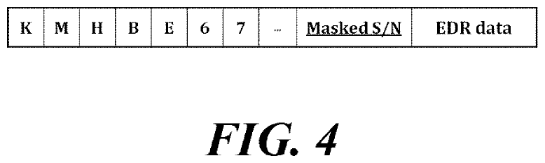

FIG. 4 illustrates an example of a de-identified version of a VIN. In the de-identified version of a VIN, digits other than a production serial number are plain text and thus allow meaningful statistical analysis on EDR data collected from multiple vehicles. For example, it is possible to analyze EDR data generated from vehicles of “2018 Avante model produced in North America.”

In the case of a model with a very small production number, information, such as model, series, and model year of a vehicle, may enable tracking of the vehicle or a related owner. Accordingly, in the case of such a model, a process similar to the de-identification process performed on a production serial number may be further performed on at least some of the tenth to seventeenth digits of a VIN, which correspond to a VIS, and the fourth to eighth digits of the VIN, which correspond to a VDS.

Link data (in particular, pseudonymous identifiers) itself does not include any meaningful information that identifies a vehicle or individual, but the link data may be cryptographically reconstructed based on the vehicle identification information (VII) and salt stored in the VII database. Accordingly, the relationship between the VII and the EDR/DSSAD data may be tracked from the VII database to the EDR/DSSAD databases, but tracking is impossible in the reverse direction. It is noted that, in some embodiments, an operator of EDR/DSSAD databases may be a service provider independent of the operator of other functional elements of the cloud storage system 20 including the VII database. In such embodiments, as long as the VII database is securely managed, such independent service providers may use or distribute EDR/DSSAD data with little risk to the privacy of a vehicle owner.

Further, by deleting the vehicle identification information or salt used to reconstruct the link data from the VII database, the association between the vehicle identification information and related EDR/DSSAD data may be removed. When it is required to remove an association between the vehicle identification information and the EDR/DSSAD data, the repository coordinator 25 maintains the EDR/DSSAD data in the related databases, but may delete the vehicle identification information or salt from the VII database. This may be useful when the operating entities of the VII database and the EDR/DSSAD databases are different from each other.

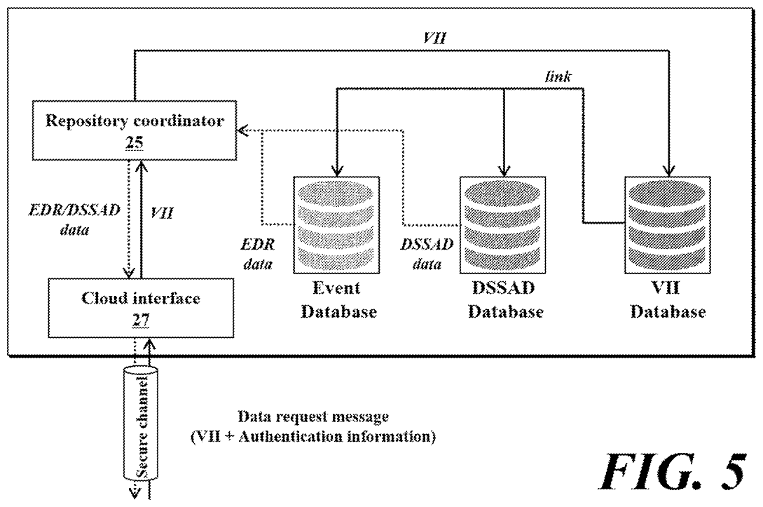

Referring to FIG. 5, an exemplary method for the cloud storage system 20 to inquire and provide EDR/DSSAD data for a specific vehicle is described.

Upon receiving a data request message requesting EDR/DSSAD data for a specific vehicle through the security channel, the cloud interface 27 may authenticate whether a requester is a vehicle owner who is the data subject or a third party with legitimate authority. The data request message may include authentication information and VII of a specific vehicle. When the authentication is successful, the repository coordinator 25 may acquire the salt stored together with the VII of a vehicle by inquiring the VII database. The repository coordinator 25 may reconstruct the link data from VII and the salt. The repository coordinator 25 may retrieve EDR data and DSSAD data from the EDR database and the DSSAD database, respectively, using the link data. The repository coordinator may log data requests and consequent inquiry tasks, and reply the EDR data and DSSAD data to a requestor.

Most privacy-related regulations, such as GDPR, ensure that data subjects have the right to control the use, management and disposition of data. To this end, the cloud storage system 20 may establish a privacy policy including a set of privacy rules to be applied for a procedure for collecting and managing EDR/DSSAD data from each vehicle.

The rule/policy manager 23 may operate a web server that provides a graphical user interface through which a vehicle owner can select one or more privacy options to apply for EDR/DSSAD data. The rule/policy manager 23 of the cloud storage system 20 may receive, from the vehicle owner, a selection of privacy options for the EDR/DSSAD data of the vehicle. Selection of the privacy options may be made when the vehicle owner subscribes to the cloud storage system 20 or registers his/her vehicle, or at some point after registration. Exemplary privacy options selectable are listed.
Opt-out: an option for the vehicle owner to specify one or more data elements that are not allowed to be collected from the owner's vehicle.
Opt-in: an option for the vehicle owner to specify one or more data elements that are permitted to be collected from the owner's vehicle.
Restricted use: an option for the vehicle owner to limit the purposes for which collected data is permitted to be used.
De-identification: an option for the vehicle owner to grant a permission to collect data from the owner's vehicle, but to have any association with the vehicle or individual removed first to permit use of the data by a third party.

The rule/policy manager 23 may generate a set of privacy rules applicable to the EDR/DSSAD data of the vehicle in accordance with the selection (or private options) made by a vehicle owner, and store the generated set of privacy rules in the privacy policy-related database. The set of privacy rules may be defined in a markup language such as Extensible Markup Language (XML).

Even after subscribing to the cloud storage system 20, a vehicle owner has the right to request the cloud storage system to delete personal data (VII/EDR/DSSAD data), and in response to the request, the cloud storage system 20 undertakes the obligation to delete personal data without undue delay.

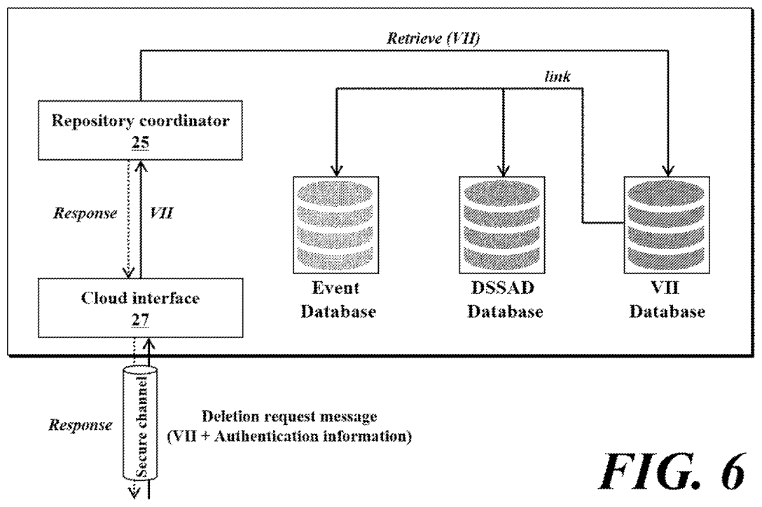

Referring to FIG. 6, an exemplary method in which the cloud storage system 20 deletes VII/EDR/DSSAD data per the request of a vehicle owner is described.

Upon receiving a deletion request message requesting deletion of vehicle-generated data through the security channel, the cloud interface 27 may authenticate whether a requestor is a vehicle owner who is the data subject. The deletion request message may include authentication information and the VII of a related vehicle. When the authentication is successful, the repository coordinator 25 may acquire the salt stored together with the VII of the vehicle by inquiring the VII database. The repository coordinator 25 may reconstruct the link data from the VII and the salt. The repository coordinator 25 may retrieve EDR data and DSSAD data from the EDR database and the DSSAD database using the link data, respectively, and delete EDR/DSSAD data corresponding to the link data. The repository coordinator may record a log for a deletion request and a corresponding deletion task, and respond to a requester with a result of the execution.

The request for deletion from a vehicle owner may further include selection of data to be deleted from among VII and EDR/DSSAD data. At the selection of the vehicle owner, the cloud storage system 20 may selectively delete VII and EDR/DSSAD data from the databases.

A vehicle owner may request deletion of only VII or link data to allow EDR/DSSAD data to be used by third parties with no association with a vehicle or individual. When only the VII or link data is deleted, the cloud storage system 20 may mitigate a security level for the privacy rule (for example, a right to use or a right to access) of the related EDR/DSSAD data. For example, the cloud storage system 20 may retain EDR/DSSAD data with VII deleted, use the same for research purposes, or provide the same to third parties, without restrictions on the purpose or period of use set by the vehicle owner. Accordingly, event data or interaction data whose security level is mitigated may be allowed to be retrieved directly from the second database or the third database without reconstructed link data.

In some embodiments, when a validity period set by a vehicle owner expires, the cloud storage system 20 may maintain the related EDR/DSSAD data in the EDR/DSSAD databases, but may delete the related VII or salt from the VII database. Accordingly, even after the validity period set by the vehicle owner has expired, the EDR/DSSAD data may be used for statistical analysis with no association with the VII data. Even in such a case, upon receiving an explicit deletion request from the vehicle owner, the cloud storage system 20 also needs to delete the EDR/DSSAD data. In some other embodiments, when the usage period set by the vehicle owner expires, the cloud storage system may selectively delete only the EDR/DSSAD data whose usage period has expired while retaining the related VII data.

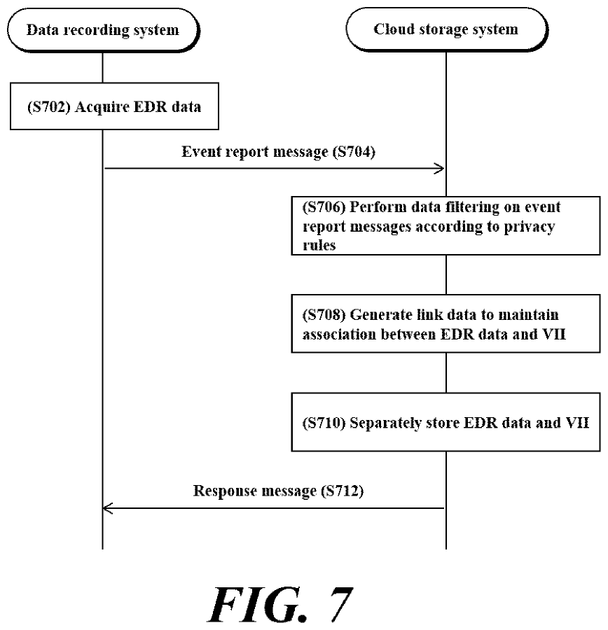

Hereinafter, with reference to FIG. 7, a process for collecting and storing EDR data in the system shown in FIG. 1 will be described. A similar process may be performed to collect and store DSSAD data.

FIG. 7 is a flow diagram illustrating an EDR data collection process of the system shown in FIG. 1.

In S702, the telecommunication device 15 of the in-vehicle data recording system 10 acquires the event data from at least one module including the EDR 11, ECU, component, program, or the like. For example, the telecommunication device 15 may receive, from the EDR 11, the EDR data recorded when triggered at the occurrence of an event, and may additionally collect the geographic location, date, time and so on where and when the event occurred.

In S704, the telecommunication device 15 generates an event report message and wirelessly transmits the event report message to the cloud storage system 20 on a network. The event report message may include EDR data and vehicle identification information. The event report message may further include additional information such as geographic location, the date and time the event occurred, vehicle model, year of manufacture, manufacturer, and so on.

In S706, the repository coordinator 25 of the cloud storage system 20 acquires the privacy rules relating to the vehicle from the privacy policy-related database of the data repository 29. In accordance with privacy rules, the repository coordinator 25 may be configured to perform preprocessing (that is, data filtering) on the event report message such as extracting data elements that are allowed to be collected or removing data elements that are not allowed to be collected from the event report message received from the vehicle.

In S708, the repository coordinator 25 may generate link data for maintaining the association between the EDR data and the vehicle identification information (VII), which would be stored in different databases, for the preprocessed event report message. Link data may be generated based on the VII and a salt that is a randomly generated value.

In S710, the repository coordinator 25 may store the first data set including the VII and the salt in the VII database. In addition, the repository coordinator 25 may store the second data set including the EDR data and the link data in an event database.

In S712, the cloud storage system 20 may transmit, to the in-vehicle data recording system 10, a response message indicating a success with the storing of the event data.

It should be understood that the above-described exemplary embodiments can be implemented in many different ways. In some examples, the various methods, devices, servers, (sub)system described in this disclosure may be implemented by at least one general-purpose computer having a processor, memories, disk or other mass storage, communication interface, input/output (I/O) devices and other peripheral. A general-purpose computer can function as an apparatus, server, system, etc. that performs the above-described methods by loading software instructions into a processor, and then executing instructions to perform the functions described in this disclosure.

Meanwhile, the various methods or functions described in embodiments of the present disclosure may be implemented with instructions stored in a non-transitory recording medium, which can be read and executed by one or more processors. Non-transitory recording media includes, for example, all types of recording devices in which data is stored in a form readable by a computer system. For example, non-transitory recording media include storage media such as erasable programmable read-only memory (EPROM), electrically erasable programmable read-only memory (EEPROM), flash drives, optical drives, magnetic hard drives, and solid state drives (SSDs).

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

1.-20. (canceled)

21. A method, performed by at least one server on a network, for collecting and managing vehicle-generated data from a vehicle, the method comprising:
receiving an event report message and an interaction report message from the vehicle, the event report message comprising vehicle identification information and event data stored by an event data recorder of the vehicle, and the interaction report message comprising the vehicle identification information and interaction data indicative of an interaction between an autonomous driving system of the vehicle and a driver;
generating link data from the vehicle identification information and a salt;
storing the vehicle identification information and the salt in a first database;
storing the event data and the link data in a second database; and
storing the interaction data and the link data in a third database.

22. The method of claim 21, further comprising deleting the vehicle identification information or the salt from the first database when it is desired to remove an association between the vehicle identification information and the event data or an association between the vehicle identification information and the interaction data.

23. The method of claim 21, further comprising maintaining the event data and the interaction data in the second database and the third database and deleting the vehicle identification information of the vehicle or the salt from the first database in response to expiration of a validity period set by a vehicle owner of the vehicle.

24. The method of claim 21, further comprising:
receiving a request message requesting deletion of the vehicle identification information, the event data, or the interaction data; and
deleting the vehicle identification information, the link data, the event data, or the interaction data from a related database in response to receiving the request message.

25. The method of claim 24, further comprising mitigating a security level of a right to use related event data and interaction data stored in the second database and the third database in an event of deleting the vehicle identification information or the salt from the first database.

26. The method of claim 25, wherein:
the event data or the interaction data for which the security level is not mitigated is retrieved from the second database or the third database based on the link data reconstructed from the salt and related vehicle identification information stored in the first database; and
the event data or the interaction data for which the security level is mitigated is allowed to be retrieved directly from the second database or the third database without the reconstructed link data.

27. The method of claim 21, wherein the link data is generated by applying a one-way hash function to the vehicle identification information and the salt.

28. The method of claim 21, wherein the vehicle identification information is a vehicle identification number (VIN), and the link data is a de-identified version of the VIN generated from the salt and the VIN.

29. The method of claim 21, wherein the link data is a de-identified version of a vehicle identification number (VIN) generated by generating a hash value by applying a one-way hash function to a concatenation of the salt and a subset of digits of the VIN of the vehicle and replacing the subset of digits of the VIN with the hash value.

30. The method of claim 29, wherein the subset of digits comprises a production serial number.

31. A cloud storage system, implemented by at least one server on a network, for collecting and managing vehicle-generated data from a vehicle, the system comprising:
means for receiving an event report message and an interaction report message from the vehicle, the event report message comprising vehicle identification information and event data stored by an event data recorder of the vehicle, and the interaction report message comprising the vehicle identification information and interaction data indicative of an interaction between an autonomous driving system of the vehicle and a driver;
means for generating link data from the vehicle identification information and a salt;
means for storing the vehicle identification information and the salt in a first database;
means for storing the event data and the link data in a second database; and
means for storing the interaction data and the link data in a third database.

32. The system of claim 31, further comprising means for deleting the vehicle identification information or the salt from the first database when it is desired to remove an association between the vehicle identification information and the event data or an association between the vehicle identification information and the interaction data.

33. The system of claim 31, further comprising means for maintaining the event data and the interaction data in the second database and the third database and deleting the vehicle identification information of the vehicle or the salt from the first database in response to expiration of a validity period set by a vehicle owner of the vehicle.

34. The system of claim 31, further comprising:
means for receiving a request message requesting deletion of the vehicle identification information, the event data, or the interaction data; and
means for deleting the vehicle identification information, the link data, the event data, or the interaction data from a related database in response to receiving the request message.

35. The system of claim 34, wherein a security level of a right to use related event data and interaction data stored in the second database and the third database is mitigated in an event of deleting the vehicle identification information or the salt from the first database.

36. The system of claim 35, wherein:
the event data or the interaction data for which the security level is not mitigated is retrieved from the second database or the third database based on the link data reconstructed from the salt and related vehicle identification information stored in the first database; and
the event data or the interaction data for which the security level is mitigated is allowed to be retrieved directly from the second database or the third database without the reconstructed link data.

37. The system of claim 31, wherein the link data is generated by applying a one-way hash function to the vehicle identification information and the salt.

38. The system of claim 31, wherein the vehicle identification information is a vehicle identification number (VIN), and the link data is a de-identified version of the VIN generated from the salt and the VIN.

39. The system of claim 31, wherein the link data is a de-identified version of a vehicle identification number (VIN) generated by generating a hash value by applying a one-way hash function to a concatenation of the salt and a subset of digits of the VIN of the vehicle and replacing the subset of digits of the VIN with the hash value.

40. The system of claim 39, wherein the subset of digits comprises a production serial number.
